(19) United States
(12) Patent Application Publication
(10) Pub. No.: US 2026/0161668 A1
(43) Pub. Date: Jun. 11, 2026

(54) PAYLOAD ARRANGEMENT FOR EFFICIENT PAYLOAD RECEPTION FROM NETWORK STORAGE

(71) Applicant: Stripe Inc., South San Francisco, CA (US)

(72) Inventors: Sai Sankalp ARRABOLU, Kenmore, WA (US); Reed TREVELYAN, Arlington, VA (US); James REILLY, Jamaica Plain, MA (US); Sauhard BINDAL, San Francisco, CA (US); Nigel ELLIS, Redmond, WA (US); Suryatej MUKKAMALLA, San Mateo, CA (US); Rohan Vinod NAIR, Seattle, WA (US); Asavari TAYAL, San Carlos, CA (US)

(73) Assignee: Stripe Inc., South San Francisco, CA (US)

(21) Appl. No.: 18/972,767

(22) Filed: Dec. 6, 2024

(51) Int. Cl. G06F 16/28; G06F 16/248; H04L 41/22

(52) U.S. Cl. CPC G06F 16/287; G06F 16/248; H04L 41/16; H04L 41/22; H04L 45/08

(57) ABSTRACT

A method and related systems may use a language model to generate queries or other commands to retrieve data from a set of databases. Some embodiments may incorporate data attribute descriptors or example commands in an input context of a model input for the language to improve the efficiency, accuracy, or reliability of the model-generated command.

### SUMMARY

Networked data storage nodes in modern databases offer powerful advantages like scalability, fault tolerance, and geographic distribution for lower latency, but they come with significant querying challenges. When data is spread across multiple nodes, a conventional user attempting to write a query may need to know how to best access nodes and how to combine these results efficiently. The user may need to consider these factors in view of additional concerns, such as the data schema of a data system and relationships between different data structures within the data system. The scalability of data-related applications may depend on optimizing database queries and their payload efficiency, as poorly structured query payloads can create bottlenecks that ripple throughout the entire system. In theory, users may try to use a language model to generate queries to reduce the complexity of queries. However, naïve implementations of a language model may frequently produce inefficient searches that improperly construct query payloads in a search command, resulting in inordinate latency between the times when a user requests and receives requested data. Worse, naïve implementations may create incorrect searches, incomplete searches, or even complete nonsense searches due to a lack of familiarity with a data system.

Some embodiments may perform operations for decreasing network search latency and increasing search reliability when using a search command generated by a language model. In connection with receiving a user search request, some embodiments may assign the user request with a request classification. Some embodiments may then generate an input for a language model using data associated with this request classification to significantly increase the accuracy and efficiency of a query output generated by the language model.

Some embodiments may provide a language model with a context-augmented input to generate a more efficient or accurate query having a set of query commands and associated query payloads. For example, some embodiments may select historical queries mapped to a request classification or attribute descriptors for data tables, graphs, or other data structures of a set of databases associated with the request classification. Some embodiments may then construct an input context that arranges these queries or descriptors in a structured text sequence that enables the language model to generate system-specific commands adapted to the set of databases. By using an input context with this request-specific data, the language model may then generate a reduced-latency network command that is adapted to the set of databases indicated by the input context. In contrast to the execution of a network command that was produced by a naively implemented language model, the execution of such a reduced-latency network command may be far more efficient with respect to latency, accuracy, and other performance metrics.

Various other aspects, features, and advantages of the invention will be apparent through the detailed description of the invention and the drawings attached hereto. It is also to be understood that both the foregoing general description and the following detailed description are examples and are not restrictive of the scope of the invention.

### BRIEF DESCRIPTION OF THE DRAWINGS

FIG. 1 shows an example system generating a network command by using descriptors of attributes or payloads, in accordance with one or more embodiments.

FIG. 2 shows a conceptual diagram of an operation to generate a network command by using descriptors of attributes or payloads, in accordance with one or more embodiments.

FIG. 3 shows a flowchart of a process for generating a network command by using descriptors of attributes or payloads, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

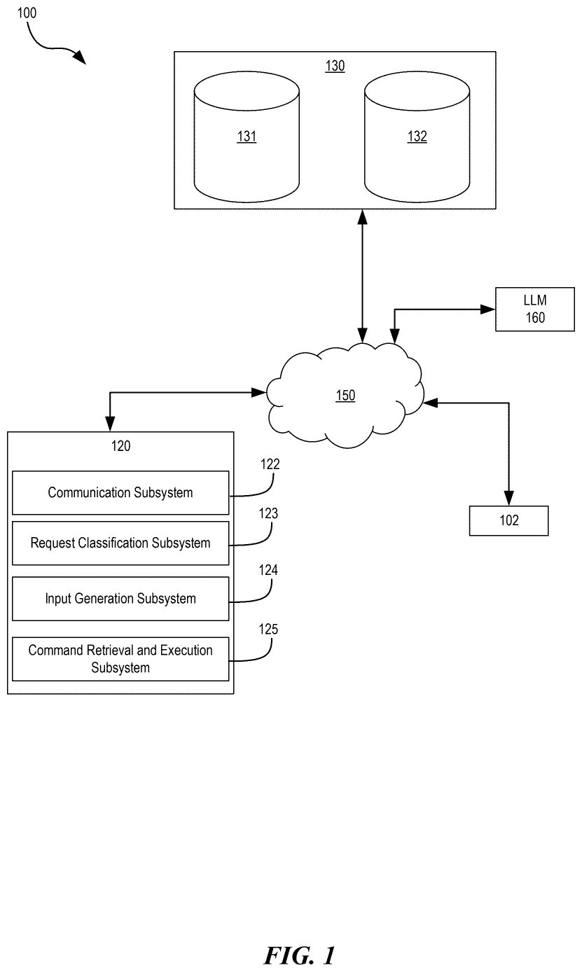

FIG. 1 shows an example system 100 generating a network command by using descriptors of attributes or payloads, in accordance with one or more embodiments. A system 100 includes a client device 102 in communication with a server 120 via a network 150, where the server 120 may also be communicating with a language model system 160. As will be described further in this disclosure, the server 120 may perform operations to generate a model input for a language model used to obtain a command, such as a query for data from one or more databases.

In some embodiments, the system 100 may assign a request with a request classification based on an obtained request to generate future commands that are more efficient or accurate. A request may include a request for data from one or more data storage systems, such as a networked set of data stores (e.g., a set of networked storage nodes). For example, some embodiments may classify a request with request classification “class1” based on the request including an explicit request to retrieve data from a database. For example, some embodiments may assign the request classification “spending aggregate” to a request based on a determination that the request includes the phrase “total amount of spending.” Alternatively, some embodiments may use machine learning methods to determine the request classification. By assigning the request classification with a category, downstream operations involving values and other data mapped to this request classification may be quickly implemented. Some embodiments may then retrieve the relevant descriptors, use the descriptors as part of an input for a language model, and retrieve a command from the language model to efficiently retrieve data from one or more databases. Such efficiency may include improvements in reducing a network latency, increasing a network throughput, or fewer computational resource use per query or other command. Such operations may enable the efficient retrieval of data without requiring that the user requesting the data have an intimate knowledge of the data architecture of the databases the user is attempting to access.

In some embodiments, the system 100 may first assign a request classification to a request and obtain a set of attribute descriptions for a set of data attributes, the set of attribute descriptions associated with the request classification and including or otherwise indicating a set of potential payload values. For example, some embodiments may retrieve the attribute descriptor for the data attribute “user_id” based on an association between the data attribute and a request classification assigned to the request. By retrieving the set of attribute descriptions based on the request classifications, some embodiments may use this set of attribute descriptions to generate a future command that is related to the attributes or the data tables (or other type of data sets) storing the attributes. Some embodiments may then use this set of attribute descriptions to construct an efficient and accurate downstream, machine-generated command involving one or more query payloads.

After classifying a request and retrieving appropriate attribute descriptors based on the request, the system 100 may use these attribute descriptors as input contexts to guide a prompt. By using these attribute descriptors in a model input context, some embodiments may increase the accuracy or efficiency of future commands involving these corresponding attributes. For example, some embodiments may more efficiently structure payloads in a query or validate payload values in a query based on these attribute descriptors. This resulting query may result in lower network latency or greater network throughput when used to retrieve data from a database network. Furthermore, by including one or more example queries or other example commands, some embodiments may increase the likelihood that a favored, efficient query will be produced from a language model.

Some embodiments may perform operations described in this disclosure to reduce the number of calls to a database system for queries formed from natural language questions. For example, some embodiments may receive a natural language question or even multiple natural language questions as part of a shared input. Some embodiments may then perform operations described in this disclosure by determining a set of question-specific example queries or question-specific schemas to incorporate into a question-specific input context. Some embodiments may then submit this question-specific input context with a language model in conjunction with a prompt to generate a database query based on the input context to generate a call-reduced query based on the natural language questions. By determining query payload structures and generating a query that reduces the calls in a query, a computer system reduces the volume of calls to a database while responding to various queries. Moreover, a computer system that uses selected example queries and database-specific schemas to determine payload structure of a query may enhance database performance due to the system's ability to adapt to optimized queries or schemas.

The client device 102 may include one of various types of computing devices, such as a laptop, a tablet, a desktop, a payment kiosk, a payment terminal, a smartphone, etc. The client device 102 may send requests, responses, or other messages to the server 120 that may require communication with other computing devices or other electronic devices. Additionally, the server 120 may include various types of computing units, such as physically separate servers, virtual nodes hosted on one or more physical machines, or nodes on a cloud computing system. Applications, services, or other operations may use data provided by the client device 102, the server 120, or a set of databases 130. The set of databases 130 may include various types of databases, such as SQL databases, no SQL databases, graph databases, etc. In some embodiments, the server 120 may perform one or more operations related to a communication subsystem 122, a request classification subsystem 123, an input generation subsystem 124, or a command retrieval and execution subsystem 125.

In some embodiments, the communication subsystem 122 may obtain program instructions, commands, queries, parameters, values, or other data from the client device 102 that may cause the retrieval of attribute descriptors, the generation of an input, or the execution of a command. For example, the communication subsystem 122 may receive requests to execute a database transaction from the client device 102 that causes the server 120 to query the set of databases 130. Furthermore, operations performed by the server 120 may use the communication subsystem 122 to send messages to the set of databases 130, the client device 102, the language model system 160, or another computing device described in this disclosure. For example, the communication subsystem 122 may send out queries from the server 120 to the set of databases 130.

In some embodiments, the request classification subsystem 123 may assign the request with a request classification based on the contents of the request, metadata associated with the request, or other data associated with the request. A request classification may represent a set of intended data types that are mapped to one or more databases, one or more data sets (e.g., a data table, a graph, etc.), or one or more attributes of a data set. For example, a set of intended data types may include a specific type of user identifier, a device identifier, a session identifier, a network performance metric, etc.

Some embodiments may use a rules-based operation to assign a request classification based on one or more keywords or key phrases in the request matching with a listed keyword or key phrase that is mapped to a request classification. Alternatively, or additionally, some embodiments may use a statistical method to determine a request classification. Alternatively, or additionally, some embodiments may use a machine learning model to determine a classification. For example, some embodiments may determine a set of request classifications for a request by providing the request to a trained neural network that outputs one or more categories representing request classifications. A request classification for a request may be as simple as an indication that a specific data table (or another type of data set) or other data source is associated with the request.

In some embodiments, the input generation subsystem 124 may use data associated with a request classification determined using the request classification subsystem 123 or otherwise associated with a request and generate a model input for a language model. Some embodiments may retrieve attribute descriptors that are associated with a request classification or otherwise associated with a request. For example, some embodiments may retrieve attribute descriptors from the set of databases 130 based on associations between the attribute descriptors and the request classification, where such associations may include though not be limited to references (e.g., pointers to memory address, database foreign keys, aliases, etc.), identifiers, such as unique values usable for a lookup or matching operation, index values in one or more indexes, semantic links, etc. In some embodiments, a request classification may be associated with attribute descriptors, such as table annotations, table column annotations, descriptors for specific portions of a data table, metadata associated with a data table or table column, text descriptions stored directly in a data table or other data structure, property descriptions of objects, descriptions for another field in a data record, etc.

In some embodiments, the input generation subsystem 124 may use the descriptor data to populate an input context for a model input. For example, some embodiments may determine that a set of descriptors for a corresponding set of three columns in a data table are relevant descriptors for a request based on a set of mappings between a request classification for the request and the set of descriptors. Some embodiments may then incorporate the set of descriptors along with the table name of the data table into an input context. Furthermore, some embodiments may determine that multiple sets of descriptors in multiple data tables are associated with one or more request classifications assigned to a request. Some embodiments may generate an input context that includes these multiple sets of descriptors and order or otherwise organize these descriptors by the names of their corresponding data tables.

Alternatively, or additionally, the input generation subsystem 124 may update an input context for a model input to include one or more positive examples of what the structure of an output should look like. Alternatively, or additionally, the input generation subsystem 124 may update the input context to indicate, with one or more negative examples, what the structure of an output should not look like. For example, some embodiments may retrieve a set of historic queries or other historic set of commands associated with one or more request clarifications associated with the request. For example, some embodiments may retrieve a first set of historic queries based on an association between the set of historic queries and the request classification and then incorporate one or more queries of the first set of historic queries in the input context of the model input. In addition to incorporating the queries or other commands themselves in a model input, some embodiments may indicate whether the incorporated queries or other commands are positive examples of functional commands or negative examples of commands that will not function.

In some embodiments, the input generation subsystem 124 may generate a model input that includes a prompt indicating a user's text input and an input context that is provided in conjunction with the prompt. For example, the server 120 may first receive a user's request from the client device 102. The server 120 may then use the input generation subsystem 124 to construct a language model input that includes the user request as a prompt and an input context that includes data table attribute descriptors associated with a request classification assigned to the request.

In some embodiments, the command retrieval and execution subsystem 125 may send the model input generated by the input generation subsystem 124 to the language model system 160. The language model system 160 may include at least one of a set of computer devices executing a language model or an application program interface (API) to a large language model. For example, the language model system 160 may include a set of servers or an API to a transformer-based large language model (LLM). In some embodiments, the LLM may include a commercial or proprietary model Alternatively, or additionally, the LLM may include an open source model. The language model system 160 may then output a command in response to the model input, where the command may include one or more program instructions to retrieve data from a set of databases.

In some embodiments, the command retrieval and execution subsystem 125 may retrieve a set of commands from the language model system 160 and then execute the set of commands. For example, the command retrieval and execution subsystem 125 may retrieve a query to retrieve a set of values from a first network database 131 and a second network database 132, where the set of databases 130 includes the first network database 131 and the second network database 132. When an input context that includes attribute descriptors for data tables in the set of databases 130 is used to generate an augmented query, the organization of the payloads and other structural elements of the augmented query may provide a more efficient or accurate search operation.

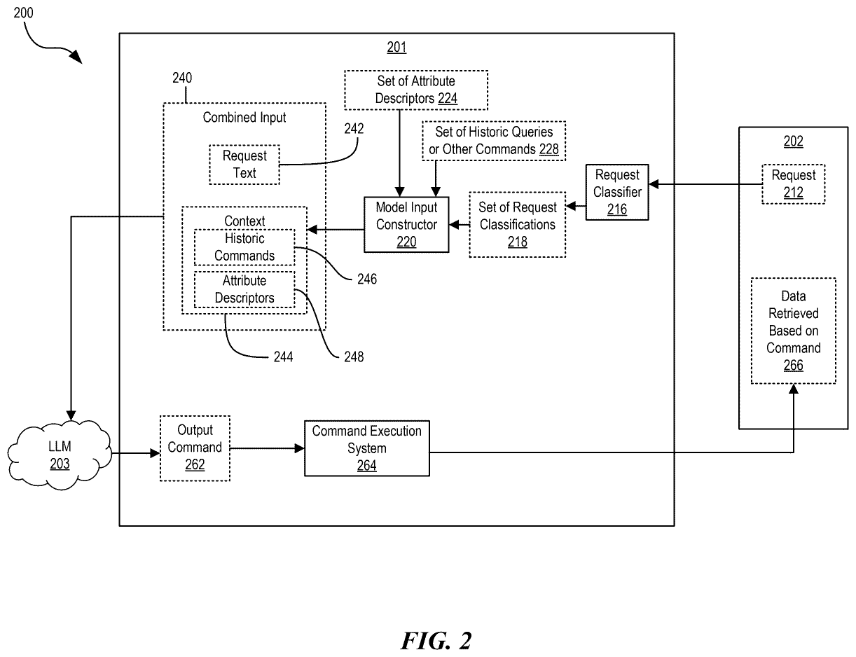

FIG. 2 shows a conceptual diagram of an operation to generate a network command by using descriptors of attributes or payloads, in accordance with one or more embodiments. In some embodiments, the system 200 depicts a server system 201, a client device 202, and a language model system 203. In some embodiments, the server system 201 may or may not include a physical server (e.g., an on-premises server). Alternatively, or additionally, the server system 201 may or may not include a cloud server (e.g., as a virtual machine, as a cloud instance, as a cluster).

The server system 201 may provide a request 212 to a request classifier 216 of the server system 201. The request classifier 216 may generate a set of request classifications 218 based on the request 212. As described elsewhere in this disclosure, the request classifier 216 may use a rules-based implementation to match text with keywords or key phrases to determine one or more classifications for the set of request classifications 218. Alternatively, or additionally, the request classifier 216 may use a machine learning model, such as a neural network model, to process the request 212 and determine one or more classifications of the set of request classifications 218.

The server system 201 may send the set of request classifications 218 to a model input constructor 220. The model input constructor 220 may determine what data is associated with the set of request classifications 218 and use it to construct a model input 240. As shown in FIG. 2, the model input constructor 220 may select and retrieve a set of attribute descriptors 224 and a set of historic queries or other commands 228. The model input constructor 220 may make this selection based on an association between the set of attribute descriptors 224. the set of historic queries or other commands 228 and the set of request classifications 218.

The model input constructor 220 may use the collected data to generate the model input 240. The model input 240 may include request text 242, where the request text 242 may include some or all of the text from the request 212. The model input 240 may also include an input context 244, where the input context 244 includes a set of example commands 246 and a set of attribute descriptors 248. The set of example commands 246 may include some or all of the commands of the other commands 228. The set of attribute descriptors 248 may include some or all of the attribute descriptors of the set of attribute descriptors 224.

The server system 201 may send the model input 240 to the language model system 203. The language model system 203 may use the information in the input context 244 to generate a more accurate or efficient command in the form of an output command 262. The output command 262 may include a query for a set of network databases or another network command that involves sending or retrieving data through a network of devices. The server system 201 may then use a command execution system 264 to execute the output command 262. Execution of the output command 262 causes the retrieval of database data 266. The server system 201 may send the database data 266 to the client device 202.

### Flowchart

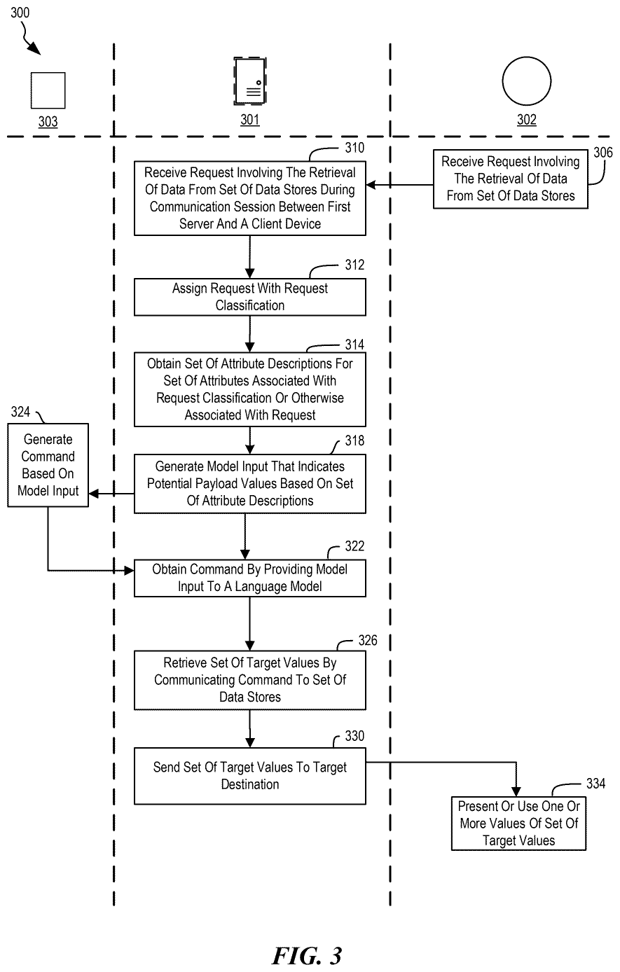

FIG. 3 shows a flowchart of a process for generating a network command by using descriptors of attributes or payloads, in accordance with one or more embodiments. The process 300 is shown as a swimlane flowchart, in which column 301 represents operations performed by client system, column 302 represents operations performed by a server system, and column 303 represents operations performed by a large language model system. It should be understood that descriptions of an operation being performed by a system are exemplary and non-limiting, such that operations described as being performed by one system may instead be performed by another system unless described otherwise. For example, one or more operations described as being performed by a server system may instead or also be performed by a client system.

Some embodiments may receive a request involving the retrieval of data from a set of data stores, as indicated by block 306. In some embodiments, operations of the block 306 may be performed by a client system, as shown in column 302. The client device may include a user interface (UI), where a user may enter a text prompt or other prompt (e.g., an image, audio recording, video data, etc.). The client device may then send the request to a server system.

Some embodiments may receive a request involving the retrieval of data from a set of data stores during a communication session between a first server and a client device, as indicated by block 310. In some embodiments, operations of the block 310 may be performed by a server system, as shown in column 301. In some embodiments, the request may include an explicit request to retrieve data from the set of data stores. For example, in an online banking session, the first server may receive an authenticated request from a user's web browser to display the amount of resources consumed over a period of time, where such data may be stored in a set of databases. Alternatively, or additionally, the request may include an implicit request to perform an operation that requires retrieving data from a set of data sources. For example, a user's request may include instructions to transfer funds or otherwise reallocate resources, where such operations may include a verification operation that would require the server to verify whether the user has a record indicating that the user has sufficient resources (e.g., sufficient funds, sufficient computing resources to allocate, etc.).

Some embodiments may assign a request with a request classification, as indicated by block 312. In some embodiments, operations of the block 312 may be performed by a server system, as shown in column 301. Some embodiments may assign the request with a request classification based on keywords or key phrases included in the request or databases indicated in the request. For example, if a request includes the key phrase “node resources,” some embodiments may assign the request classification “node resource database request” to the request. Alternatively, or additionally, some embodiments may apply an encoder model involving a simple set of neural network layers or a transformer-based model to generate a set of embeddings. Some embodiments may then assign one or more request classifications to a request based on embeddings generated from the request.

Some embodiments may obtain a set of attribute descriptions for a set of attributes associated with a request classification or otherwise associated with the request, as indicated by block 314. In some embodiments, operations of the block 314 may be performed by a server system, as shown in column 301. In some embodiments, the set of attribute descriptions may be directly mapped to the request classification. For example, some embodiments may assign the request clarification “class1” to a request and then retrieve a set of three paragraphs representing three attribute descriptions, where the request classification “class1” directly maps to these three attribute descriptions in a dictionary or in a property associated with the request classification “class1.” Alternatively, some embodiments may first detect that a request classification is mapped to one or more data sources, such as databases, trees, or other data structures.

In some embodiments, the attribute descriptions may indicate potential payload values, where the potential payload values may be used to validate the payload values used in a generated query downstream. Alternatively, or additionally, one or more potential payload values may be used within a generated query. For example, an attribute description may recite, for an attribute titled “resource_id,” “Unique identifier for computing resource, e.g. RES_789.”

Some embodiments may use a vector-based method to determine one or more categories for a request or a command associated with the request. Some embodiments may use a set of neural networks or other machine learning models to categorize the request. For example, some embodiments may provide the request to a transformer-based neural network model (e.g., Bidirectional Encoder Representations from Transformers, Generative Pretrained Transformer, Language Model for Dialogue Applications, etc.) to determine a set of vectors for the request, a set of vectors representing one or more query intents. Some embodiments may then search a vector database using the set of vectors to retrieve one or more attribute descriptions. For example, some embodiments may search the set of attribute descriptions using a respective vector to obtain a set of nearest vectors based on distances between the set of nearest vectors and the respective vector in vector space.

Some embodiments may use models and methods to enable scalability and rapid answer retrieval to concurrently handle thousands, hundreds of thousands or even more retrieval operations. For example, some embodiments may use a low-layer neural network embedding model (e.g., Word2Vec, Global Vectors for Word Representation, FastText, etc.). In some embodiments, a low-layer neural network model may include fewer than three neural network layers, where having fewer than three neural network layers may be advantageous for processing speed and concurrency of operations. Some embodiments may use a low-layer neural network model to create an initial set of embeddings and then use the initial set of embeddings to one or more final vectors (e.g., intent vectors). For example, some embodiments may use Word2Vec to generate an initial set of vectors based on a user prompt, determine an average vector from the set of vectors, and assign the average vector to the user prompt. Some embodiments may then determine a distance based on this average vector and other vectors, where distance calculations may involve fast distance calculations, such as cosine similarity searches or another angular similarity operation. By using an angular similarity operation, some embodiments may accelerate search operations, where such operations may be especially useful in applications where a vector space direction is sufficient to indicate a likely set of databases or attributes to use for databases.

Some embodiments may generate a model input that indicates potential payload values based on the set of attribute descriptions, as indicated by block 318. In some embodiments, operations of the block 318 may be performed by a server system, as shown in column 301. Some embodiments may generate the model input based on the attribute descriptions, where these attribute descriptions may be ordered by or otherwise organized by a set of identifiers of the set of data sets (e.g., data tables, databases, other data structures) used for storing the attributes. In some embodiments, the model input may construct an input from a user-provided prompt and an input context corresponding with the user-provided prompt, where the set of attribute descriptions may be used to construct this input context. For example, a model input may include an input context, where the input context may include attribute descriptors for attributes in “Resources” table, an “Applications” table, and a “Client” table. In some embodiments, the input context may be or include structured text that is ordered by the data table identifiers, where the structured text may be or include the following:

[Resources Table:
resource_id: “Unique identifier for computing resource, e.g.
RES_789”
resource_type: “Resource category with values like CPU,
MEMORY, STORAGE”
allocation_status: “Current state as READY, IN_USE, OFFLINE”

Application Table:
app_id: “Application identifier, e.g. APP_123”
resource_id: “Foreign key linking to resources.resource_id”
app_status: “Application state as RUNNING, STOPPED, ERROR”

Client Table:
client_id: “Client identifier, e.g. CLT_456”
app_id: “Foreign key linking to applications.app_id”
connection_state: “Connection status as ACTIVE, IDLE,
DISCONNECTED”′

Furthermore, as shown in the above example, the input context may include indications relations between different tables, as evidenced by the inclusion of the phrase “Foreign key linking to resources.resource_id” for the data table “Application.”

Alternatively, or additionally, some embodiments may provide example queries as part of an input context of a constructed model input. In some embodiments, a server, client, or other set of computer systems may retrieve a set of stored network commands (i.e., historic network commands) associated with a request classification. Some embodiments may then include these historic network commands in the input context of a model input. For example, some embodiments may determine that a request should be classified with the category “cat05” and, in response, retrieve a set of for example queries associated with this category. When constructing a model input, some embodiments may update the input context of the model input or another part of the model input with the set of example queries. Some embodiments may further indicate that these example queries are examples using additional text in the input context or another portion of the model input. Furthermore, other network commands (e.g., connectivity testing commands, network configuration commands, and network monitoring commands) or other types of commands may be obtained using operations described in this disclosure (e.g., initiating a node, initiating an application, sending parameters to an application, etc.).

Some embodiments may determine whether a command, such as a query command, provided any search results. Based on a determination that a previously used command provided no search results, some embodiments may choose to include the previously used command in an input context in conjunction with an indication that the previously used command had provided no search result. For example, based on a determination that a first query in a collection of historic queries did not yield any search results, some embodiments may incorporate this query in an input context of a model input and then indicate that this command yielded no results.

Some embodiments may assign one or more categories to a request that indicates which query language or other type of command language to use when constructing the command. For example, some embodiments may determine that a request should be associated with a query language category based on the set of data stores to be used, where the query language category may indicate query languages, such as a SQL-based language or a non-SQL-based query language. When retrieving historic commands to include in an input context, some embodiments may filter a set of historic commands by the language category. For example, based on a determination that a request may require data from a first database that is designed to be accessed with graphQL, some embodiments may select historic commands written in the graphQL language.

Some embodiments may receive, from a client device, an indication that the performance of a generated command has satisfied one or more relevant criteria and, in response, include this generated command as another historic command to include from a set of historic commands. For example, a request prompting the generation of a network command may be assigned a first set of request categories. Some embodiments may then determine that a network latency associated with the network command is below a latency threshold. In response, some embodiments may select this network command and add the selected command to a data set of selected commands, where the set of historic commands may be selected from the data set of selected commands. For example, based on a determination that a first command has a latency less than a threshold of 50 milliseconds, some embodiments may select this first command and add the selected command to a data set of selected commands.

In some embodiments, the attribute descriptor included in a model input or some other portion of the model input may include an indication of whether a data attribute is indexed. For example, the input context of a model input may include, for the data table “Resource,” the text “resource_id: (indexed) Unique identifier for computing resource” to indicate that “resource_id” is an indexed attribute in “Resource.” By pointing out which attributes are indexed, a language model may more accurately construct an efficient query or other database-using command by relying on indexed values of a data table.

Some embodiments may indicate that one or more attributes is a composite index for a data table. For example, some embodiments may generate a model input that includes, for an “applications” data table, the text ‘Application: “app_id, client_id” (composite index, int: 789, 456) . . . ’ to indicate that the composite index in the “Applications” table combines “app_id” and “client_id.” By pointing out which attributes are composite indexes, some embodiments may provide a language model with data useful to increase the likelihood of the language model accurately constructing an accurate query that takes advantages of data consistencies in a set of data tables, such as a set of data tables distributed in a networked set of data stores (e.g., a set of networked storage nodes, a set of networked servers having their own respective databases, a set of decentralized devices, etc.). Furthermore, some embodiments may indicate other types of relationships between different data tables or some other type of different data sets. For example, some embodiments may indicate that the value of a first attribute in a first data table includes a link or another type of reference to the value of a second attribute in a second data table.

In some embodiments, the structured text of a model input or another portion of the model input may indicate different data sets for different attribute descriptions by using one or more symbols or characters to indicate these differences. Such symbols or characters may include markup language tags, delimiter characters, or specialized markers. For example, the text description in the input context for a model input may include XML-style tags, colon delimiters, or bracketed tags to show the separation of different sets of attributes or different sets of data tables in an input context.

Some embodiments may detect an indication of a failure or another type of negative feedback from a user or another computer system and, in response, perform a rehabilitative action, such as indicating that one or more attributes lack a foreign key reference. Some embodiments may obtain an indication of failure associated with a command (e.g., a query) or a set of target values retrieved using the command. Some embodiments may then determine whether a first data attribute of a data table indicated in the command is missing one or more foreign key references. Based on a termination that this data attribute is missing one or more foreign key references, some embodiments may then generate a warning that indicates that this data attribute is missing a foreign key reference. For example, some embodiments may determine that a request for application connections was not previously answered correctly due to a missing foreign key reference in a particular data table used to retrieve data for this request. In response, some embodiments may generate a warning indicating this data table or attribute of this data table. Alternatively, or additionally, some embodiments may generate a test to prevent a similar issue involving this attribute in future uses of this data table.

Some embodiments may suppress discrepancies in descriptions or other obtained data to reduce confusion and erroneous outputs. Some embodiments may determine that an attribute of a set of attributes retrieved using operations described in this disclosure is associated with multiple attribute descriptions. For example, some embodiments may detect that a first description provided by a first user and a second description provided by a second user refer to the same candidate attribute in the same table. In response, some embodiments may combine the descriptions or generate a summary from the descriptions. Alternatively, or additionally, some embodiments may delete a contradictory description or otherwise suppress the description from being used in an input context. For example, when generating a structured text to include a text description of the candidate attribute, some embodiments include the first description of the multiple attribute descriptions and does not include a second description. Some embodiments may select the first description in lieu of the second description based on a prioritization of the user providing the first description over the user providing the second description. Alternatively, or additionally, some embodiments may select the first description based on a comparison with other descriptions and a determination that the first description is more consistent with the other descriptions based on a comparison set of embedding vectors generated from the first description, second description, and other description.

Some embodiments may generate a command based on a model input, as indicated by block 324. In some embodiments, operations of the block 324 may be performed by a language model system, as shown in column 303. In some embodiments, a language model system may be hosted on its own set of servers or may connect to a third-party language model. Alternatively, some embodiments may host a language model system in the same set of devices used to perform one or more operations described as being performed for operations shown in column 301. In some embodiments, the language model system may use a large language model to generate an output response, where the output response may be or may include a command, such as a database query for a single database or a network command involving retrieving data from a set of networked storage nodes.

Some embodiments may obtain a command by providing the model input to a language model, as indicated by block 322. In some embodiments, operations of the block 322 may be performed by a server system, as shown in column 301. Some embodiments may obtain a command (e.g., a network command) by transmitting the model input to the model. In some embodiments, the obtained command may be a latency-reduced network command that includes a set of payloads. In some embodiments, the latency-reduced aspect of a latency-reduced network command may be discovered in comparison to a network command that is naively generated by a language model without the set of attribute descriptions obtained using operations described for block 312. Furthermore, in some embodiments, the set of payloads may include at least one attribute identifier of the data attributes. For example, in some embodiments, a language model may generate a query that includes a filter for the data attribute “attribute1” after being provided with a user request and an input context that indicates the importance of “attribute1” in fulfilling that request.

Some embodiments may retrieve a set of target values by communicating the command to a set of data stores, as indicated by block 326. In some embodiments, operations of the block 326 may be performed by a server system, as shown in column 301. For example, some embodiments may use operations described in this disclosure to generate, as a network command, the following example cross-database join query for monitoring network status:

```
SELECT dev.hostname, interfaces.status, performance.bwdth_util, alerts.severity
  FROM network_db.devices
    JOIN config_db.interfaces
      ON devices.id = interfaces.device_id JOIN metrics_db.performance
        ON devices.id = performance.dev_id JOIN security_db.alerts
          ON devices.id = alerts.dev_id WHERE alerts.severity =
        ‘worrisome’
          OR interfaces.status != ‘ON’.”
```

Some embodiments may send the set of target values to a target destination, as indicated by block 330. In some embodiments, operations of the block 330 may be performed by a server system, as shown in column 301. In some embodiments, the target destination may include a client device used to send the initial request involving the retrieval of data from a set of data stores. In some embodiments, the client device may present, on a visual display, such as a display screen, the set of target values, etc. Alternatively, or additionally, a client device or other computer system may provide the set of target values to an application executing on the client device or other computer system as inputs or parameters to update a display of the client device or other pewter system.

Some embodiments may present or use one or more values of the set of target values, as indicated by block 334. In some embodiments, operations of the block 334 may be performed by a client system, as shown in column 303. For example, a client device may directly display a set of values retrieved using operations described for block 326. Alternatively, or additionally, a client device may use one or more values retrieved using operations described for block 326 as inputs for an application of the client device to execute one or more operations of the application.

It should be understood that any assignment of an operation to a particular component or system is not restricted to that component or system unless specified as being exclusively limited to that system. For example, while a server system may perform operations of column 301 as indicated in the process 300, one or more operations described as being performed in column 301 may be performed instead by a client system or another computer system.

The above-described embodiments of the present disclosure are presented for purposes of illustration and not of limitation, and the present disclosure is limited only by the claims which follow. Furthermore, it should be noted that the features and limitations described in any embodiment may be applied to one or more other embodiments herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. Furthermore, not all operations of a flowchart need to be performed. In addition, the systems and methods described herein may be performed in real time. It should also be noted that the systems and/or methods described above may be applied to, or used in accordance with, other systems and/or methods.

Furthermore, the computing devices described in this disclosure may be any type of computing device unless otherwise stated, including, but not limited to, a laptop computer, a tablet computer, a hand-held computer, and/or other computing equipment (e.g., a server), including “smart,” wireless, wearable, and/or mobile devices. For example, the client device 102 of FIG. 1 may be a smartphone, another type of mobile computing device, or a payment terminal. Furthermore, the embodiments described in this disclosure may include an individual device that performs some or all the operations described in this disclosure. Alternatively, other embodiments may include multiple computing devices acting collectively to perform some or all the operations described in this disclosure.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on one or more non-transitory, machine-readable media (e.g., a set of machine-readable storage media), such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods.

In some embodiments, the various computer systems and subsystems illustrated in FIG. 1 or FIG. 2 may include one or more computing devices that are programmed to perform the functions described herein. The computing devices may include one or more electronic storages (e.g., a set of databases accessible to one or more applications depicted in the system 100), one or more physical processors programmed with one or more computer program instructions, and/or other components. For example, the set of databases may include one or more relational databases. Alternatively, or additionally, the set of databases or other electronic storage used in this disclosure may include one or more non-relational databases.

The computing devices may include communication lines or ports to enable the exchange of information with a set of networks (e.g., a network used by the system 100) or other computing platforms via wired or wireless techniques. The network may include the internet, a mobile phone network, a mobile voice or data network (e.g., a 5G or Long-Term Evolution (LTE) network), a cable network, a public switched telephone network, or other types of communication networks or combination of communication networks. A network described by devices or systems described in this disclosure may include one or more communication paths, such as Ethernet, a satellite path, a fiber-optic path, a cable path, a path that supports internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via port (e.g., a USB port, a firewire port, etc.) or drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems described in this disclosure or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of the subsystems described in this disclosure may provide more or less functionality than is described. For example, one or more of subsystems described in this disclosure may be eliminated, and some or all of its functionality may be provided by other ones of subsystems described in this disclosure. As another example, additional subsystems may be programmed to perform some or all of the functionality attributed herein to one of the subsystems described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than a mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X′ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing item. Thus, updating a record may include generating a record or modifying the value of an already-generated value in a record. Additionally, as used in the specification, “a portion” refers to a part of, or the entirety of (i.e., the entire portion), a given item (e.g., data) unless the context clearly dictates otherwise.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

### Enumerated Embodiments

The present techniques will be better understood with reference to the following enumerated clauses:

1. A method comprising: receiving a request involving data stored in a set of data stores; obtaining a set of attribute descriptions for a set of attributes based on the request; generating a model input by generating a structured text comprising the set of attribute descriptions; obtaining a command based on the model input; retrieving a set of target values by communicating the command to the set of data stores.
2. A method comprising: receiving a request involving data stored in a set of data stores; obtaining a set of example commands based on the request; generating a model input comprising the example commands; obtaining a command based on the model input; retrieving a set of target values by communicating the command to the set of data stores.
3. A method comprising: receiving, during a communication session with a client device, a request for data stored in a set of data stores; obtaining a set of attribute descriptions for a set of attributes that is associated with a request classification for the request; generating a model input by generating a structured text comprising the set of attribute descriptions, wherein the structured text is based on a set of identifiers of a set of data sets comprising the set of attributes; obtaining, via a model, a command by transmitting the model input to the model; retrieving, from one or more data stores of the set of data stores, a set of target values by communicating the command to the set of data stores; and sending, to the client device, the set of target values.
4. A method comprising: in connection with a user request received during a communication session between a first server and a client device, assigning, based on content of the user request, the user request with a request classification representing a set of intended data types, wherein the user request comprises a request for data from networked storage nodes accessible by the first server; obtaining, based on the assignment of the request classification, attribute descriptions for data attributes that (1) are associated with the request classification and (2) indicate potential payload values; generating, with the first server, a model input comprising a structured text based on the attribute descriptions and structured by identifiers of data sets comprising the data attributes; obtaining, via a language model executed by a second server, a latency-reduced network command comprising a set of payloads that includes at least one attribute identifier of the data attributes by sending the model input to the language model executed by the second server; presenting, on a visual display of the client device, a set of target values by executing the latency-reduced network command to retrieve the set of target values from one or more data stores of the networked storage nodes.
5. A method for increasing network throughput by retrieving descriptors for generating future commands, comprising: receiving, during a communication session between a first server and a client device, a request for data stored in a networked set of data stores; assigning the request with a request classification; obtaining, based on the assignment of the request classification, a set of attribute descriptions for a set of attributes that is associated with the request classification; generating, with the first server, a model input comprising a structured text based on the set of attribute descriptions, wherein the structured text is ordered by a set of identifiers of a set of data sets comprising the set of attributes; obtaining, via a language model executing on a second server, a network command by transmitting the model input to the language model executing on the second server; retrieving, from one or more data stores of the networked set of data stores, a set of target values by communicating the network command to the networked set of data stores; and presenting, on a visual display of the client device, the set of target values.
6. The method of any of the embodiments above, wherein generating the model input comprises: generating the structured text based on the set of attribute descriptions; and constructing the model input to comprise the request as a prompt of the model input and the structured text as part of an input context of the model input.
7. The method of any of the embodiments above, further comprising retrieving a set of historic commands associated with the request classification, wherein constructing the model input comprises constructing the model input to comprise the set of historic commands as part of an input context of the model input.
8. The method of any of the embodiments above, further comprising determining a result indicating that a previously used command provided no search results, wherein the set of historic commands comprises the previously used command.
9. The method of any of the embodiments above, wherein retrieving the set of historic commands comprises: determining a query language category associated with the networked set of data stores; and retrieving the set of historic commands based on the query language category.
10. The method of any of the embodiments above, wherein the set of attribute descriptions comprises identifiers of whether a first data attribute of the set of attributes is indexed.
11. The method of any of the embodiments above, wherein the set of attribute descriptions comprises an indication that the first data attribute is indexed in a composite index.
12. The method of any of the embodiments above, wherein the structured text indicates different data sets for different attribute descriptions based on a use of markup language tags, delimiter characters, or specialized markers.
13. The method of any of the embodiments above, further comprising: obtaining an indication of failure associated with the network command or the set of target values; determining a result indicating that a first data attribute indicated in the network command is missing a foreign key reference; and generating a warning indicating the first data attribute based on the result.
14. The method of any of the embodiments above, wherein: assigning the request with the request classification comprises generating an intent vector representing query intent by providing the request to a neural network; obtaining the set of attribute descriptions comprises: obtaining a set of nearest vectors by searching a vector database based on a distance from the intent vector in vector space; and obtaining the set of attribute descriptions based on associations between the set of attributes and the set of nearest vectors.
15. The method of any of the embodiments above, wherein: the neural network comprises fewer than three neural network layers; and searching the vector database comprises determining the distances using an angular similarity operation.
16. The method of any of the embodiments above, wherein generating the model input comprises generating the model input by constructing the model to comprise the request and the structured text.
17. The method of any of the embodiments above, further comprising determining that an attribute of the set of attributes is associated with multiple attribute descriptions, wherein generating the structured text comprises generating the structured text to include a first description of the multiple attribute descriptions and to not include a second description of the multiple attribute descriptions.
18. The method of any of the embodiments above, further comprising retrieving a set of historic commands associated with the request classification, wherein constructing the model input comprises constructing the model input to comprise the set of historic commands.
19. The method of any of the embodiments above, wherein retrieving the set of historic commands comprises retrieving the set of historic commands from a data set of selected commands, the operations further comprising: determining that a latency associated with the command is below a latency threshold; and updating the data set of selected commands to comprise the command.
20. The method of any of the embodiments above, wherein generating the structured text comprises generating the structured text to comprise an indication of a reference between different data sets of the set of data sets.
21. The method of any of the embodiments above, wherein the set of attribute descriptions comprises identifiers of whether a first data attribute of the set of attributes is indexed.
22. The method of any of the embodiments above, further comprising: obtaining an indication of failure associated with the command or the set of target values; determining a result indicating that a first data attribute indicated in the command is missing a foreign key reference; and generating a warning indicating the first data attribute based on the result.
23. A tangible, non-transitory, machine-readable medium storing instructions that, when executed by a data processing apparatus, cause the data processing apparatus to perform operations comprising those of any of embodiments 1-22.
24. A system comprising one or more processors; and memory storing instructions that, when executed by the processors, cause the processors to effectuate operations comprising those of any of embodiments 1-22.
25. A system comprising means for performing any of embodiments 1-22.

What is claimed is:

1. A system for decreasing network latency when generating a network command by retrieving descriptors of payloads for generating future commands, the system comprising one or more processors and one or more machine-readable media storing program instructions causing the one or more processors to perform operations comprising:
in connection with a user request received during a communication session between a first server and a client device, assigning, based on content of the user request, the user request with a request classification representing a set of intended data types, wherein the user request comprises a request for data from networked storage nodes accessible by the first server;
obtaining, based on the assignment of the request classification, attribute descriptions for data attributes that (1) are associated with the request classification and (2) indicate potential payload values;
generating, with the first server, a model input comprising a structured text based on the attribute descriptions and structured by identifiers of data sets comprising the data attributes;
obtaining, via a language model executed by a second server, a latency-reduced network command comprising a set of payloads that includes at least one attribute identifier of the data attributes by sending the model input to the language model executed by the second server;
presenting, on a visual display of the client device, a set of target values by executing the latency-reduced network command to retrieve the set of target values from one or more data stores of the networked storage nodes.

2. A method for increasing network throughput by retrieving descriptors for generating future commands, comprising:
receiving, during a communication session between a first server and a client device, a request for data stored in a networked set of data stores;
assigning the request with a request classification;
obtaining, based on the assignment of the request classification, a set of attribute descriptions for a set of attributes that is associated with the request classification;
generating, with the first server, a model input comprising a structured text based on the set of attribute descriptions, wherein the structured text is ordered by a set of identifiers of a set of data sets comprising the set of attributes;
obtaining, via a language model executing on a second server, a network command by transmitting the model input to the language model executing on the second server;
retrieving, from one or more data stores of the networked set of data stores, a set of target values by communicating the network command to the networked set of data stores; and
presenting, on a visual display of the client device, the set of target values.

3. The method of claim 2, wherein generating the model input comprises:
generating the structured text based on the set of attribute descriptions; and
constructing the model input to comprise the request as a prompt of the model input and the structured text as part of an input context of the model input.

4. The method of claim 2, further comprising retrieving a set of historic commands associated with the request classification, wherein constructing the model input comprises constructing the model input to comprise the set of historic commands as part of an input context of the model input.

5. The method of claim 4, further comprising determining a result indicating that a previously used command provided no search results, wherein the set of historic commands comprises the previously used command.

6. The method of claim 4, wherein retrieving the set of historic commands comprises:
determining a query language category associated with the networked set of data stores; and
retrieving the set of historic commands based on the query language category.

7. The method of claim 2, wherein the set of attribute descriptions comprises identifiers of whether a first data attribute of the set of attributes is indexed.

8. The method of claim 7, wherein the set of attribute descriptions comprises an indication that the first data attribute is indexed in a composite index.

9. The method of claim 2, wherein the structured text indicates different data sets for different attribute descriptions based on a use of markup language tags, delimiter characters, or specialized markers.

10. The method of claim 2, further comprising:
obtaining an indication of failure associated with the network command or the set of target values;
determining a result indicating that a first data attribute indicated in the network command is missing a foreign key reference; and
generating a warning indicating the first data attribute based on the result.

11. The method of claim 2, wherein:
assigning the request with the request classification comprises generating an intent vector representing query intent by providing the request to a neural network;
obtaining the set of attribute descriptions comprises:
obtaining a set of nearest vectors by searching a vector database based on a distance from the intent vector in vector space; and
obtaining the set of attribute descriptions based on associations between the set of attributes and the set of nearest vectors.

12. The method of claim 11, wherein:
the neural network comprises fewer than three neural network layers; and
searching the vector database comprises determining the distances using an angular similarity operation.

13. One or more non-transitory, machine-readable media storing program instructions that, when executed by one or more processors, causes the one or more processors to perform operations comprising:
receiving, during a communication session with a client device, a request for data stored in a set of data stores;
obtaining a set of attribute descriptions for a set of attributes that is associated with a request classification for the request;
generating a model input by generating a structured text comprising the set of attribute descriptions, wherein the structured text is based on a set of identifiers of a set of data sets comprising the set of attributes;
obtaining, via a model, a command by transmitting the model input to the model;
retrieving, from one or more data stores of the set of data stores, a set of target values by communicating the command to the set of data stores; and
sending, to the client device, the set of target values.

14. The one or more non-transitory, machine-readable media of claim 13, wherein generating the model input comprises generating the model input by constructing the model to comprise the request and the structured text.

15. The one or more non-transitory, machine-readable media of claim 13, further comprising determining that an attribute of the set of attributes is associated with multiple attribute descriptions, wherein generating the structured text comprises generating the structured text to include a first description of the multiple attribute descriptions and to not include a second description of the multiple attribute descriptions.

16. The one or more non-transitory, machine-readable media of claim 13, further comprising retrieving a set of historic commands associated with the request classification, wherein constructing the model input comprises constructing the model input to comprise the set of historic commands.

17. The one or more non-transitory, machine-readable media of claim 16, wherein retrieving the set of historic commands comprises retrieving the set of historic commands from a data set of selected commands, the operations further comprising:
determining that a latency associated with the command is below a latency threshold; and
updating the data set of selected commands to comprise the command.

18. The one or more non-transitory, machine-readable media of claim 13, wherein generating the structured text comprises generating the structured text to comprise an indication of a reference between different data sets of the set of data sets.

19. The one or more non-transitory, machine-readable media of claim 13, wherein the set of attribute descriptions comprises identifiers of whether a first data attribute of the set of attributes is indexed.

20. The one or more non-transitory, machine-readable media of claim 13, further comprising:
obtaining an indication of failure associated with the command or the set of target values;
determining a result indicating that a first data attribute indicated in the command is missing a foreign key reference; and
generating a warning indicating the first data attribute based on the result.
